(19) United States
(12) Patent Application Publication
(10) Pub. No.: US 2010/0011019 A1
(43) Pub. Date: Jan. 14, 2010

(54) Database Business Components Code Generator

(76) Inventor: Danny M. Scarboro, Savannah, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 12/561,914

(22) Filed: Sep. 17, 2009

Related U.S. Application Data
(63) Continuation-in-part of application No. 11/187,338, filed on Jul. 22, 2005.

(51) Int. Cl. G06F 17/30

(52) U.S. Cl. 707/102; 707/E17.009; 707/E17.044

(57) ABSTRACT

In a method for generating components for accessing a data source, input is received from a user interface, allowing access to the data source. A list of structural elements employed in the data source is created. A data object corresponding to the structural elements employed in the data source is automatically generated. At least one business object component is automatically generated. The business object component includes a plurality of stored data operations that accesses data in the data source, wherein the data corresponds to the structural elements in the desired structure of the data object.

### CROSS-REFERENCE TO RELATED APPLICATION(S)

This application is a continuation-in-part of, and claims the benefit of, U.S. patent application Ser. No. 11/187,338, filed Jul. 22, 2005, the entirety of which is hereby incorporated herein by reference.

### BACKGROUND OF THE INVENTION

1. Field of the Invention

The present invention relates to computer systems and, more specifically, to a system for creating software application components.

2. Description of the Prior Art

Computer data sources are used to store data. Many data sources store massive amounts of data. Therefore, a data source has a predetermined organizational structure according to which data is stored so that the data, once stored, may be retrieved in a predetermined manner. Examples of data sources include databases, tables and XML strings. A database typically has a structure similar to a table, in which predetermined amounts of data on a storage medium correspond to rows and subsets of data in each row correspond to columns. Typically, units of data in a database are organized according to a predefined relationship: hence the term “relational database.” XML stores data according to predefined schemas, or structures, but does not necessarily store data in the same type of structure as a database.

Typically, a data source is organized with a plurality of structural elements and a plurality of data fields that correspond to a specific structural element. Each structural element corresponds to a predefined type of data. For example, a data source used by a human resources department to manage employee information might be named “Employees” and include the following structural elements: “Last Name”; “First Name”; “Employee ID”; “Address”; “Social Security Number”; “Hire Date”; and “Reports To.” The data fields are organized as records, with each record in the data source including a data field for each structural element. The structural elements would also include an indication of data type; for example: VARCHAR20 (indicating that the element was a variable character string with 20 characters); INT9 (indicating that the element was an integer with nine digits); and DATETIME (indicating that the element included a date, a time, or both). In the example presented, one exemplary record might be for an employee named “Tom Jones.” This record could include the following exemplary data: Last Name: “Jones”; First Name: “Tom”; Employee ID: “XYZ123”: Address: “2822 Wood Street, Ames, Iowa, 50010”; Social Security Number: “123-45-6789”; Hire Date: “May 7, 2000”; and Reports To: “Cruella DeVille.” Similar records would be stored in the data source for other employees of the company.

A developer of applications that access data from a data source typically encodes one or more data objects that describe an organizational structure for data retrieved from a data source. A data object includes a selected set of structural elements that the developer desires to have accessed; and the set of structural elements is organized according to a desired structure. Typically, a data object is given a name that allows the developer to recognize it. Once encoded, a data object may be populated with data from the data source taken from the data fields corresponding to the structural elements selected for the data object. For example, a developer might create a data object from the above-discussed exemplary data source that would include the following structural elements and structure:

```
CREATE PROCEDURE GetEmployeeAddressList AS
SELECT
    [First Name],
    [Last Name],
    [Address]
FROM
    [Employees]
```

This data object is named “GetEmployeeAddressList” and, when executed, will retrieve from the data source named “Employees” the First Name, Last Name, and Address from each record in the data source and present the data to the user according to the structure of the data object.

Most data sources are stored on a digital medium that employs a set of rules for accessing the data stored thereon. The set of rules is usually independent of the actual data. Therefore, while the data may be organized conceptually according to a data object, the storage medium may use a separate set of stored procedures and functions in order to access the data. This set of stored procedures and functions is sometimes referred to as a “business object component.” A business object component is a collection of business objects; a business object is a stored procedure (or function) for accessing some part of a data source. Thus, a business object component is a set of stored procedures that accesses the data required for a given application.

The business object accesses data in the data source and communicates with the data object via a data access component. The data access component acts as a connection manager and data manager between the data object and the business object. Typically, a data access component can be reused through many applications run in a single data source environment or one of several data source environments.

Currently, when a developer writes an application for data source access, he must generate a data object and then write a business object component to correspond to the data object. This is typically done in a line-by-line manner. Alternatively, the developer may reuse and existing data object, but may wish to modify it. If, during the development process, the developer decides to change the data object, he must re-write the business object component to correspond to the revised data object. This can be complicated and time consuming, especially if the business object is complex. This can become even more difficult if the user decides to change the structure of the data source (e.g., by adding or deleting data fields).

Alternately, some developers write business object components that are designed to cover every possible data object that could be associated with a class of data sources. Such business object components can be extremely bulky and complicated, and can add considerable overhead to the execution of the application.

Therefore, there is a need for a system that allows a developer to generate and revise automatically data objects and corresponding business object components.

There is also a need for a system that automatically generates a data access object for communication between a data object and a business object

There is also a need for a system that generates automatically data objects and business object components based on the structure of a data source.

There is also a need for a system that allows a user to input characteristics of a data source and generate a data source structure based on the characteristics.

### SUMMARY OF THE INVENTION

The disadvantages of the prior art are overcome by the present invention which, in one aspect, is a method, operable on a digital computer by a user employing a user interface to the digital computer, for generating components for accessing a data source. The data source includes a plurality of structural elements and a plurality of data with each datum being associated with a predetermined one of the structural elements. In the method, input that allows access to the data source is received from the user interface. A list of structural elements employed in the data source is created. A data object is automatically generated according to a predefined data object generation rule. The data object corresponds to the list of structural elements. At least one business object component is automatically generated according to a predefined business object component generation rule. The business object component corresponds to the list of structural elements. The business object component accesses the data object and includes a plurality of stored data operations that accesses data in the data source. The data correspond to the structural elements in the data object.

In another aspect, the invention is a data management engine that includes a digital computer and a digital storage medium. The digital storage medium includes, stored thereon, a program that executes a plurality of steps. When executing the program, input is received from the user interface; the input allows access to the data source. A list of structural elements employed in the data source is created. An input is received from the user interface. The input indicates a desired structure for a data object. The desired structure includes at least one of the structural elements employed in the data source. A data object corresponding to the desired structure is automatically generated according to a predefined data object generation rule. At least one business object component is automatically generated according to a predefined business object component generation rule. The business object component includes a plurality of stored functions that accesses data in the data source. The data corresponds to the structural elements in the desired structure of the data object.

In yet another aspect, the invention is a computer-readable medium that stores thereon a computer program. The computer program including a plurality of steps, starting with receiving input, from the user interface, that allows access to the data source. The program creates a list of structural elements employed in the data source. The program receives an input, from the user interface, that indicates a desired structure for a data object. The desired structure includes at least one of the structural elements employed in the data source. The program automatically generates a data object corresponding to the desired structure according to a predefined data object generation rule. The program automatically generates at least one business object component, according to a predefined business object component generation rule, so that the business object component includes a plurality of stored functions that accesses data in the data source, and so that the data corresponds to the structural elements in the desired structure of the data object. The program also automatically generates a data access component to facilitate communication of data between the business object component and the data object.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of an illustrative physical embodiment of the invention.

FIG. 2 is a flow diagram showing a top-level illustrative embodiment of the invention.

FIG. 3 is a block diagram showing relationships between several elements employed in one illustrative embodiment of the invention.

FIG. 4 is a schematic diagram of an illustrative example of a user interface that may be generated by executed code employed in one illustrative embodiment of the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet. “Access to the data source” means creating the data source, reading from the data source or writing to the data source.

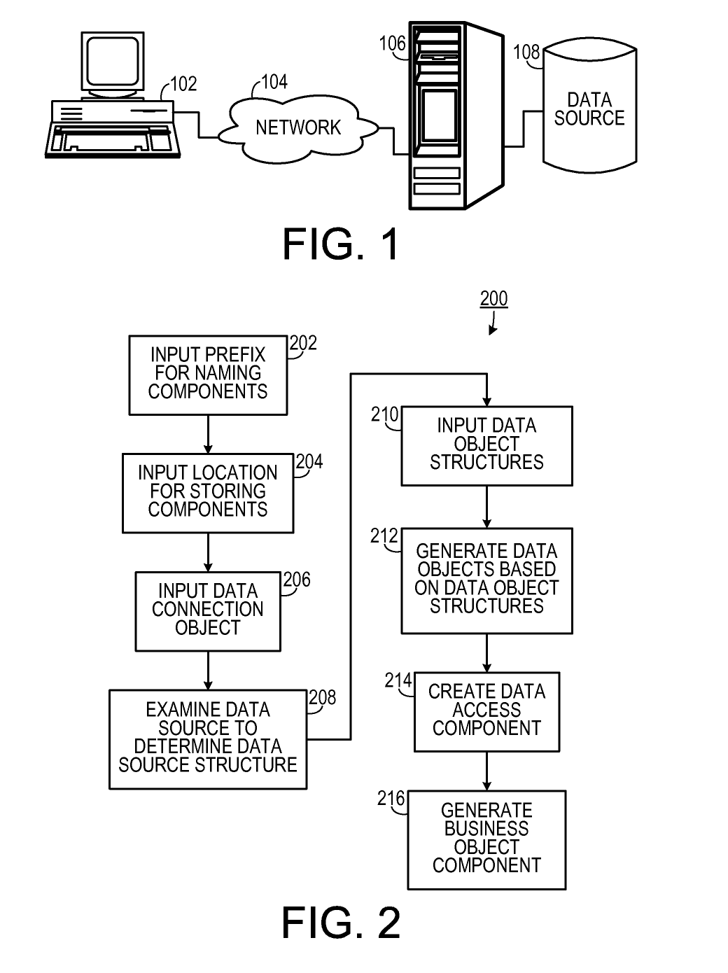

As shown in FIG. 1, in one embodiment, the invention employs a digital computer 102 that is in communication with a server 106 via a network 104 (which could include a global computer network). The server 106, typically, would store a data source 108 (such as a data base or XML string) on a computer-readable medium (such as a disk drive or any one of the many computer-readable media commonly known in the computer arts). The data source 108 typically includes at least one data object stored therein. Alternately, the invention could be embodied on a stand-alone computer, with the data source being stored on the hard drive of the computer. As will be readily appreciated by those of skill in the art, many different hardware configurations are possible with the invention and it is intended that the claims that follow are not limited to any one such hardware configuration.

The invention provides a user, such as a developer of data source applications, with a system for creating, accessing and modifying data sources, and for creating data objects and corresponding business object components used for accessing data sources. One embodiment of the invention also generates a data access component that provides communication between the data objects and the business object component. The invention gives the user a great deal of flexibility in data source application development. For example, the user might input a desired structure for a data object into the user interface and the system will generate a data base employing the data object. (The desired structure of a data object could include: a table structure; an XML file; a string; a procedure; a function; a file; a tag; a string; a user; a role; a size; a type; a data type; a length; an identity; a seed value; or an increment of a seed value, or a combination of these entities.) It will also generate the data object and a corresponding business object component, as well as a corresponding data access component. For existing data sources, the system will detect the structure of the data source and generate corresponding data objects and business object components. The user may also modify existing data sources, with the system generating corresponding data objects and business object components.

As shown in FIG. 2, one system 200 embodying the invention is a computer program stored on a computer-readable medium (such as a hard disk) that initially presents the user with a user interface in which the user inputs 202 a prefix for naming components. This prefix will be attached to some of the data objects and business object components for the sake of maintaining the cohesiveness of the output of the system 200. The user also inputs 204 a location (such as a folder name and drive name) for storing all components produced by the system 200. The user then inputs 206 a data connection object. The data connection object is typically a string that includes information necessary for accessing the data source, such as the name and location of the data source; and the user identification and password necessary to open the data source.

The system 200 then examines 208 the data source to determine its structure. Here, the system 200 generates a list of structural elements employed in the data source by retrieving a plurality of structural elements from the data source. Essentially, the system pulls data from the data source, detects the structural elements in the data and stores them in a list. This operation would include performing a string operation that compares data in the data source to a known set of structural element tags and retrieves any known structural element tags, and corresponding labels, found in the data source.

The system may receive input 210, via the user interface, indicating new data object structures that the user desires to have made. Similarly, the system may present an existing data object to the user and receive edits to the existing data object, and then generate a revised data object. Also, the user may input new structural elements into the interface and the system 200 modifies the data source to include the new structural elements. The system then generates 212 new data objects based on the user input and the structural elements found in the data source. The system will generate data objects based on the structural elements in the data source even if the user does not input any structure for new data objects. The system, in one embodiment, will generate 214 a data access component. The data access component essentially acts as an intermediary between the data objects and the business object component. The system 200 then generates 216 the business object component according to a predefined business object component generation rule. The business object component generation rule is a set of code that generates the business object component based on the structure of the data source and input from the user. The business object component includes a plurality of stored data operations that accesses data in the data source. A “stored data operation” is a set of code statements that manipulate data. One example of a stored operation is a function, which returns a value; another example is a stored procedure from which no value is returned.

A business object component may access a data object either directly or via data access component. The data access component, which can be referred to as a data access layer, has the advantage of providing an intermediary between the business object component and the data object, allowing for portability of both of these elements. In one embodiment, it is possible to associate a single user interface object to a single operating procedure within the business object component where the business object component contains a plurality of operating procedures. This gives a high level of control to the user.

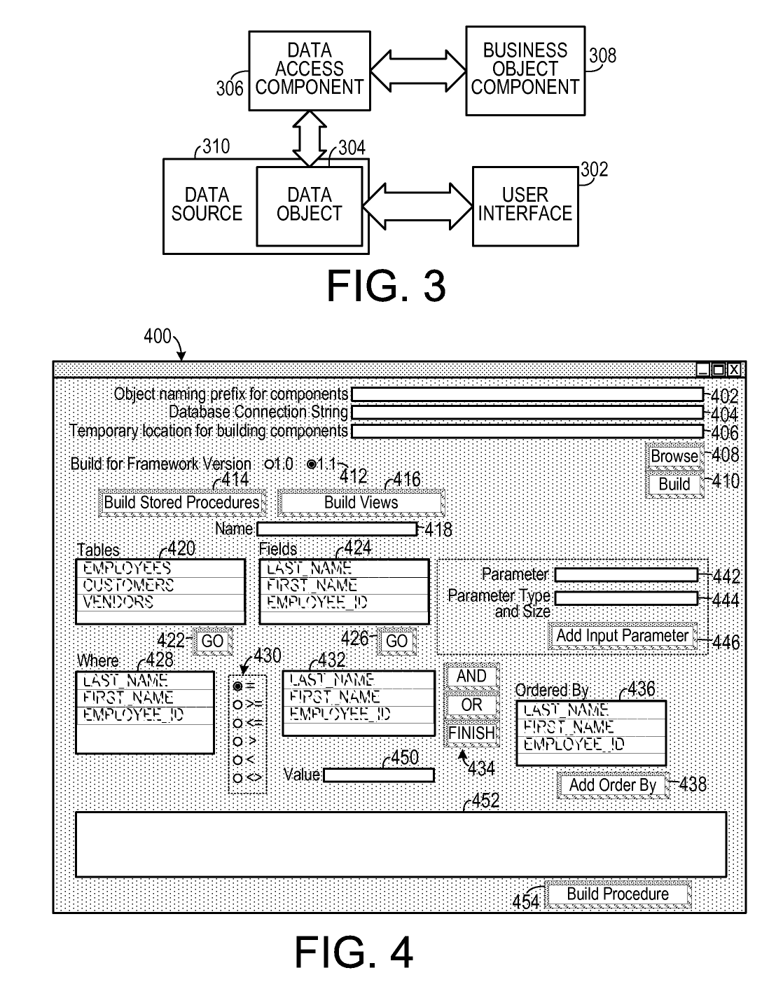

The relationships between several entities employed in the invention are shown in FIG. 3. Generally, the user interface 302 will allow a user to input information about the data source and desired modifications thereto. Once desired data is entered, the system generates at least one data object 304, which communicates with a system-generated business object component 308 via the user interface 302. A data access component 306 accessess the data object 304 through the data source 310.

One example of a user interface 400 employed with the invention is shown in FIG. 4. The user interface 400 allows the user to indicate a desired structure for a data object. The desired structure includes at least one of the structural elements employed in the data source. The user interface 400 includes several initial data input fields, including: one for entering a prefix name for all components generated by the system 402; one for entering the data source connection string 404; and one for entering a location (such as a drive letter and file name) for storing components built by the system 406, this field is associated with a Browse button 408 that allows the user to browse a file structure to find an existing location. A framework version indicator 412 may also be provided. Once the above-recited information is entered, the user may click on a Build button 410, which causes the system to examine the data source and build data objects, a data access component and a business object component based on the structure of the data source.

The user may decide to create new stored procedures (such as those used to connect to a SQL-server database) within the data source by clicking on a Build Stored Procedures button 414. Clicking a Build Views button 416 generates a forward select statement for viewing. The Build Stored Procedures button 414 activates several other elements of the user interface 400 that will be discussed below. To build a stored procedure, the user inputs a name into a Name field 418 and selects which table (for example: Employees, Customers, Vendors, etc.) the data will come from in the stored procedure from a Tables list box 420, pressing a Go button 422 to access the desired table. The user will also select which data elements (for example: Last Name, First Name, Employee ID, etc.) will be used from a Fields list box 424, pressing a Go button 426 to access the desired data elements.

The user may also include logical operations in the stored procedures by inputting a first operand, taken from a list box 428, one of a plurality of operators 430 and a second operand selected from a list box 432 or manually entered as a text value in a value field 450. The user can also select a logical operator 434 to cause ordering, the ordering criteria selected from a list box 436. An Add Order By button 438 causes the ordering selection to be added to the stored procedure. The user may also enter parameter text in a Parameter data entry field 442 and a description of the parameter in a Parameter Type and Size data entry field 444. Once parameter information is entered, it may be added to the stored procedure by clicking on an Add Input Parameter button 446.

A text box 452 displays the SQL code for the stored procedure. This text box 452 may be edited by the user, thereby allowing the user to generate SQL code for the stored procedure manually. If the user has placed code in the text box 452, clicking on a Build Procedure button 454 causes the system to generate a stored procedure corresponding to the code in the box and to place the stored procedure in a location with the other stored procedures (which could be included in the data source, depending on the type of data source).

The following is an illustrative example of data object generating code that embodies a data object generating rule (and which could be, for example, encoded in Visual BASIC):

```
Private Sub buildSelectStrings(ByVal ConnectionString As String, ByVal
txtObjectPrefix As String)
  Dim DBCon As New
  DataAccess.DataLayer.DataAccess(ConnectionString)
  Dim strReturn As String
  Dim dsTables As New DataSet
  Dim dsColumns As New DataSet
  Try
    dsTables = DBCon.executeSQLDataSet(“select * from sysobjects
    where xtype = ‘U’ order by [name]”)
  Catch ex As Exception
    getErrorMessage(ex)
    Exit Sub
  End Try
  Dim TableRow As DataRow
  Dim TableRowItemName As String
For Each TableRow In dsTables.Tables(0).Rows
  TableRowItemName = TableRow.Item(“name”)
  TableRowItemName = TableRowItemName.Replace(“ ”, “”)
  dsColumns = DBCon.executeSQLDataSet(“select [name] from
  syscolumns
  where id = (select [id] from sysobjects where [name] = ‘“ & _{—}
  TableRow.Item(“name”) & ”’ and xtype = ‘U’) order by colorder”)
  Dim ColumnRow As DataRow
  If CheckExistsStoredProcedure(ConnectionString, “[Get” &
  TableRowItemName & “]”) = True Then
    strReturn = “drop procedure [dbo].[Get“ & TableRowItemName
    & “]”
    DBCon.executeSQLWithNoReturn(strReturn)
  End If
  strReturn = “CREATE PROCEDURE Get” & TableRowItemName &
  “ AS ” &
  vbNewLine
  strReturn += “SELECT ” & vbNewLine
  Dim columnCount As Integer = 0
  For Each ColumnRow In dsColumns.Tables(0).Rows
    columnCount = columnCount + 1
      If columnCount <> dsColumns.Tables(0).Rows.Count Then
        strReturn += vbTab & “[” & ColumnRow.Item(“name”) & “], ”
        & vbNewLine
      Else
        strReturn += vbTab & “[” & ColumnRow.Item(“name”) & “] ”
        & vbNewLine
      End If
    Next
    strReturn += “FROM ” & vbNewLine & vbTab
    strReturn += “[” & TableRow.Item(“name”) & “]” & vbNewLine
    DBCon.executeSQLWithNoReturn(strReturn)
    columnCount = Nothing
    dsColumns = Nothing
    dsTables = Nothing
  Next
  DBCon = Nothing
End Sub
```

The following is an illustrative example of a data object generated with the above-listed code. This is an example of a data object created by the Data Object Generator (in this case a stored procedure called GetEmployees):

```
CREATE PROCEDURE GetEmployees AS
SELECT
    [Employee ID],
    [First Name],
    [Last Name],
    [Hire Date],
    [Reports To]
FROM
    [Employees]
```

The following is an illustrative example of Data Access Component Generating code that embodies a Data Access Component Generating rule (and which could be, for example, encoded in Visual BASIC). This is part of the string used to create a data access component which provides access to data objects. (This example shows the building of a function to run a stored procedure and return a dataset):

strReturn += “ Public Function executeSPDataSet(ByVal SPName As
String, Optional ByVal tblName As String = Nothing) As DataSet” & nl
strReturn += “” & nl
strReturn += “ ‘Set Parameter Objects” & nl
strReturn += “ Dim privateUsedParm As Parameter” & nl
strReturn += “ Dim privateParm As SqlParameter” & nl
strReturn += “ Dim usedEnum As IEnumerator =
privatePams.GetEnumerator( )” & nl
strReturn += “” & nl
strReturn += “ Try” & nl
strReturn += “ ‘Object Disposed?” & nl
strReturn += “ If privateDispBool = True Then” & nl
strReturn += “ ObjectDisposed( )” & nl
strReturn += “ End If” & nl
strReturn += “” & nl
strReturn += “ ‘Get Data (From SQL Stored Proc)” &
nl
strReturn += “ privateSQLCon =
New SqlConnection(privateConString)” & nl
strReturn += “ privateSQLCmd = New SqlCommand(SPName,
privateSQLCon)” & nl
strReturn += “ Dim privateDs As New DataSet” & nl
strReturn += “ privateSQLCmd.CommandType =
CommandType.StoredProcedure” & nl
strReturn += “” & nl
strReturn += “ ‘Loop Parms” & nl
strReturn += “ Do While usedEnum.MoveNext( )” & nl
strReturn += “ privateUsedParm = Nothing” & nl
strReturn += “ privateUsedParm = usedEnum.Current” & nl
strReturn += “ privateParm = ConvertParameters(privateUsedParm)” & nl
strReturn += “ privateSQLCmd.Parameters.Add(PrivateParm)” & nl
strReturn += “ Loop” & nl
strReturn += “” & nl
strReturn += “ privateSQLda = New SqlDataAdapter(privateSQLCmd)”
& nl
strReturn += “ If tblName = Nothing Then” & nl
strReturn += “ privateSQLda.Fill(privateDs)” & nl
strReturn += “ Else” & nl
strReturn += “ privateSQLda.Fill(privateDs, tblName)” & nl
strReturn += “ End If” & nl
strReturn += “” & nl
strReturn += “ ‘Return Data Set” & nl
strReturn += “ Return privateDs” & nl
strReturn += “” & nl
strReturn += “ Catch ExceptionObject As System.Exception” & nl
strReturn += “ CatchException(ExceptionObject)” & nl
strReturn += “ Finally” & nl
strReturn += “ ‘Close Connection” & nl
strReturn += “ privateSQLCon.Close( )” & nl
strReturn += “ End Try” & nl
strReturn += “ End Function” & nl

The following is an illustrative example of a Data Access Component generated with the above-listed code (which could be encoded, for example, in Visual Basic). This is an example of a Data Access Function created by the Data Access Component Generator. (This example shows a function used to run a stored procedure and return a dataset):

```
Public Function executeSPDataSet(ByVal SPName As String, Optional
ByVal tblName As String = Nothing) As DataSet
  ‘Set Parameter Objects
  Dim privateUsedParm As Parameter
  Dim privateParm As SqlParameter
  Dim usedEnum As IEnumerator = privateParms.GetEnumerator( )
  Try
    ‘Object Disposed?
    If privateDispBool = True Then
    ObjectDisposed( )
    End If
    ‘Get Data (From SQL Stored Proc)
    This is an example of a Data Access
    Function created by the Data Access
    Component Generator (This example
    shows a function used to run a stored
    procedure and return a dataset)
    privateSQLCon = New SqlConnection(privateConString)
    privateSQLCmd = New SqlCommand(SPName, privateSQLCon)
    Dim privateDs As New DataSet
    privateSQLCmd.CommandType = CommandType.StoredProcedure
    ‘Loop Parms
    Do While usedEnum.MoveNext( )
      privateUsedParm = Nothing
      privateUsedParm = usedEnum.Current
      privateParm = ConvertParameters(privateUsedParm)
      privateSQLCmd.Parameters.Add(privateParm)
    Loop
    privateSQLda = New SqlDataAdapter(privateSQLCmd)
    If tblName = Nothing Then
      privateSQLda.Fill(privateDs)
    Else
      privateSQLda.Fill(privateDs, tblName)
    End If
    ‘Return Data Set
    Return privateDs
  Catch ExceptionObject As System.Exception
    CatchException(ExceptionObject)
  Finally
    ‘Close Connection
    privateSQLCon.Close( )
  End Try
End Function
```

The following is an illustrative example of Business Object Component generating code (which could be encoded, for example, in visual basic). This is part of a string used to create a business component which builds procedures and functions for accessing data based upon the structure of the data source (in this case building a function to return data as a dataset):

strReturn += “Public Function Get” & RowItemName & “( ) As
System.Data.Dataset” & nltb2
strReturn += “‘OBJECT INSTANANCES” & nltb3
strReturn += “Dim DataComponent as New ” & txtObjectPrefix &
“DataAccessComponent.DataAccess” & nltb3
strReturn += “Dim dsGet” & RowItemName & “
as New System.Data.Dataset( )” & br
strReturn += “‘CONNECTION STRING” & nltb3
strReturn += “DataComponent.ConnectionString = ” & Chr(34) &
ConnectionString & Chr(34) & br
strReturn += “‘STORED PROCEDURE” & nltb3
strReturn += “dsGet” & RowItemName & “ =
DataComponent.executeSPDataSet(” & Chr(34) & “Get” &
RowItemName & Chr(34) & “, ” & Chr(34) & _{—}
strReturn += RowItemName & Chr(34) & “)” & br
Part of the string used to create
a business component which
builds procedures and functions
strReturn += “‘RETURN DATASET” & nltb3
strReturn += “Return dsGet” & RowItemName & br
strReturn += “‘CLEAN UP” & nltb3
strReturn += “dsGet” & RowItemName & “ = Nothing” & nltb3
strReturn += “DataComponent = Nothing” & nltb
strReturn += “End Function” & nltb

The following is an illustrative example of a Business Object Component generated with the above-listed code (which could be encoded, for example, in visual basic). This is an example of a Business Function created by the Business Component Generator (in this case a function used to run a stored procedure called GetEmployees and return a dataset):

```
Public Function GetEmployees( ) As System.Data.Dataset
    ‘OBJECT INSTANANCES
        Dim DataComponent as New
        CodeGrail_DataAccessComponent.DataAccess
        Dim dsGetEmployees as New System.Data.Dataset( )
    ‘CONNECTION STRING
        DataComponent.ConnectionString = ″Data Source=(local);Initial
        Catalog=CodeGrail;” &_{—}
        “Persist Security Info=False;User
        ID=CodeGrail;password=CodeGrail;workstation
        id=DANSCARBORO″
    ‘STORED PROCEDURE
        dsGetEmployees =
        DataComponent.executeSPDataSet(″GetEmployees″,
        ″Employees″)
    ‘RETURN DATASET
        Return dsGetEmployees
    ‘CLEAN UP
        dsGetEmployees = Nothing
        DataComponent = Nothing
End Function
```

In one embodiment the system enables a user to build software applications based upon selections made within a user interface. The following is one example. The system provides the user with a list of application types and the user selects to build an HTML application. The system then provides a list for connecting to an existing data source or creating a new one. In this example the user selects to create a new SQL database and inputs a database name, user id, and password. In this example the database name entered is “Products”. The system then automatically generates the data source and its structure based upon the input and selections made. The system then generates an HTML form, a build template button, a build application button, a list of controls and a list of events. The user then chooses to add a “select” control to the form. The “select” control in this example is a drop down list and will contain work order numbers belonging to work orders. As the structure for containing work order data may or may not exist in the “Products” database, the user is then given the option to use an existing table or create a new one. In this example the user chooses to create a new table with the name “WorkOrders” that will contain the “WorkOrderNumber” field. The user then selects a data type and size. In this example the data type is varchar with a size of 10. Thus indicating the “WorkOrderNumber” control and field contain variable character data limited to 10 characters in length. The user then selects the build template button and the “WorkOrders” table containing a “WorkOrderNumber” field with this structure is added to the “Products” SQL database. The system then automatically generates data objects and business objects along with a data access component. The data objects and business objects containing procedures and functions for accessing data. In this example a data object and business object both contain a “GetProductsWorkOrderNumber” function used for accessing work order number data. The data access component in this example is then used to mediate data between data objects and business objects. At this point the HTML form and controls are ready to use events to access the data. Next the user selects the “on Load” event of the “select” control to invoke the business objects “GetProductsWorkOrderNumber” function which in turn invokes the data object's “GetProductsWorkOrderNumber” function. The user then selects the build application button and the system automatically generates the application. The user then runs the application. Upon running the application the “select” control is loaded and work order number data is mediated between the database and the “select” control using the data object, business object and data access component.

In this example the user interface is used to describe and build the data source, object structures and events used to support the user interface. T hus offering true object oriented application development.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method, operable on a digital computer by a user employing a user interface to the digital computer, for generating components for accessing a data source, the data source including a plurality of structural elements and a plurality of data with each datum being associated with a predetermined one of the structural elements, the method comprising the steps of:
a. receiving input, from the user interface, that allows access to the data source;
b. creating a list of structural elements employed in the data source;
c. automatically generating a data object, corresponding to the list of structural elements, according to a predefined data object generation rule; and
d. automatically generating at least one business object component, corresponding to the list of structural elements, according to a predefined business object component generation rule, the business object component including a plurality of stored data operations that accesses data in the data source, the data corresponding to the structural elements in the data object.

2. The method of claim 1, wherein the data source includes at least one data object

3. The method of claim 1, wherein the stored data operations include at least one function.

4. The method of claim 1, wherein the stored data operations include at least one procedure.

5. The method of claim 1, further comprising the step of creating the data source based on input received from the user interface.

6. The method of claim 1, further comprising the step of receiving an input, from the user interface, indicating a desired structure for a data object, the desired structure including at least one of the structural elements employed in the data source.

7. The method of claim 6, wherein the step of receiving an input from the user indicating a desired structure for a data object includes presenting an existing data object and receiving edits to the existing data object, thereby generating a revised data object.

8. The method of claim 1, wherein the step of creating a list of structural elements employed in the data source includes receiving input including a plurality of structural elements from the user interface.

9. The method of claim 1, wherein the step of creating a list of structural elements employed in the data source includes retrieving a plurality of structural elements from the data source.

10. The method of claim 9, wherein the retrieving step comprises the steps of:
a. pulling data from the data source;
b. detecting structural elements in the data pulled from the data source; and
c. storing the structural elements detected in the data source in the list.

11. The method of claim 9, wherein the retrieving step comprises the step of opening a file in which is stored a list of structural elements found in the data source.

12. The method of claim 1, further comprising the step of presenting the user a user interface that allows the user to input the desired structure for the data object by selecting structural elements from the list of structural elements.

13. The method of claim 1, wherein the step of creating a list of structural elements employed in the data source includes retrieving a plurality of structural elements from a file.

14. The method of claim 1, wherein the desired structure comprises a structure selected from a list consisting essentially of: a table structure; an XML file; a string; a procedure; a function; a file; a tag; a string; a user; a role; a size; a type; a data type; a length; an identity; a seed value; an increment of a seed value, and combinations thereof.

15. The method of claim 1, further comprising the step of storing the data object in the data source.

16. The method of claim 1, further comprising the step of automatically generating a data access component wherein the business component communicates with the data object via a data access component.

17. A data management engine, comprising:
a. a digital computer; and
b. a digital storage medium, the digital storage medium including, stored thereon, a program that executes the following steps:
i. receive input, from a user interface, that allows access to a data source;
ii. create a list of structural elements employed in the data source;
iii. receive an input, from the user interface, that indicates a desired structure for a data object, so that the desired structure includes at least one of the structural elements employed in the data source;
iv. automatically generate a data object corresponding to the desired structure according to a predefined data object generation rule; and
v. automatically generate at least one business object component, according to a predefined business object component generation rule, so that the business object component includes a plurality of stored data operations that accesses data in the data source, and so that the data corresponds to the structural elements in the desired structure of the data object.

18. The data management engine of claim 17, wherein the business component communicates with data object via a data access component.

19. The data management engine of claim 18, wherein the program also automatically generates the data access component.

20. The data management engine of claim 17, wherein the program executes the step of accessing the data object and structural elements thereof.
